(19) United States
(12) Patent Application Publication
(10) Pub. No.: US 2022/0318911 A1
(43) Pub. Date: Oct. 6, 2022

(54) Computerized recommendation system for trading securities

(71) Applicant: Rockwell Trading Services, LLC, Austin, TX (US)

(72) Inventors: Markus Heitkotter, Dripping Springs, TX (US); Mark Hodge, Carmichael, CA (US)

(73) Assignee: ROCKWELL TRADING SERVICES, LLC, AUSTIN, TX (US)

(21) Appl. No.: 17/300,156

(22) Filed: Apr. 2, 2021

(51) Int. Cl. G06Q 40/06; G06Q 40/04

(52) U.S. Cl. CPC G06Q 40/06; G06Q 40/04

(57) ABSTRACT

A computerized recommendation system for trading securities listed in various stock exchanges which comprise of at least one processor configured to compute and store in a non-transitory memory system, multiple momentum indicators for each of a plurality of securities. The system processes the momentum indicators to shortlist securities, among the plurality of securities, that either have all their respective momentum indicators indicating a positive trend or a negative trend. The system processes data corresponding to the shortlisted securities, to identify and extract investment-worthy securities from the list of shortlisted securities, based on predefined criteria the user may use this list of investment-worthy securities to make investment decisions. The system determines at least a pair of current optimized exit price for each of the investment-worthy securities by processing historic data respective to each of the investment-worthy securities.

### BACKGROUND

Unless otherwise indicated herein, the materials described in this section are not prior art to the claims in this application and are not admitted to being prior art by inclusion in this section.

### FIELD

The subject matter in general relates to recommendation systems. More particularly, but not exclusively, the subject matter relates to computerized recommendation system for trading securities.

### DISCUSSION OF THE RELATED ART

Typically, emotions are peril to online trading, and often improper analysis of situations based on overexcitement or nervousness can lead to making significant investment mistakes. Such mistakes may be typically avoided by use of technology. Online trading has in fact witnessed influx of technology to assist traders in making informed investments decisions. Typically, these technologies use data to make objective decisions.

Conventionally, trading systems are configured with a set of rules, which are applied to select securities and generate entry and exit signals for traders. However, only indicating entry and exit prices does not always give the users the confidence to take a decision one way or the other. Furthermore, conventional systems fail to provide evidence of how successful their recommendation logic would be at a granular level, thereby leading to trust deficit in such recommendation systems. In view of the foregoing, there is a need for an improved recommendation system for trading securities.

### SUMMARY

In one aspect a computerized recommendation system is provided for trading securities listed in a stock exchange. The system comprises at least one processor configured to compute and store in a non-transitory memory system, multiple momentum indicators for each of a plurality of securities. The system processes the momentum indicators to shortlist securities, among the plurality of securities, that either have all their respective momentum indicators indicating a positive trend or a negative trend. The system processes data corresponding to the shortlisted securities, to identify investment-worthy securities among the shortlisted securities, based on predefined criteria. The system determines at least a pair of current optimized exit price for each of the investment-worthy securities by processing historic data respective to each of the shortlisted securities.

### BRIEF DESCRIPTION OF DIAGRAMS

The patent or application file contains at least one drawing executed in color. Copies of this patent or patent application publication with color drawing(s) will be provided by the Office upon request and payment of the necessary fee.

This disclosure is illustrated by way of example and not limitation in the accompanying figures. Elements illustrated in the figures are not necessarily drawn to scale, in which like references indicate similar elements and in which:

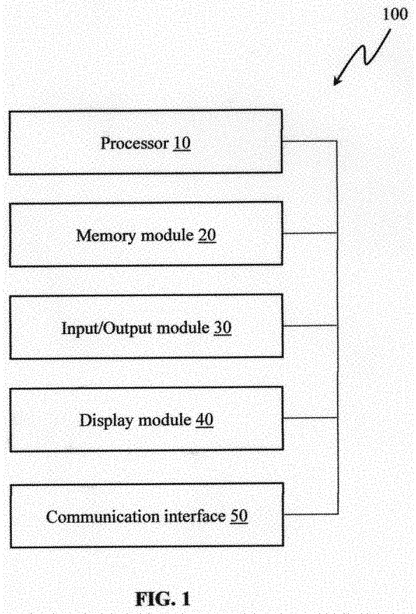

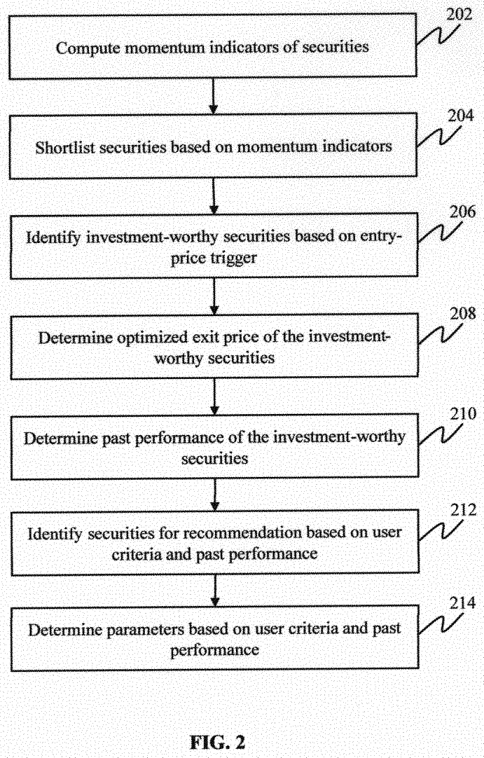

FIG. 1 illustrates a computerized recommendation system 100 for trading securities listed in a stock exchange, in accordance with an embodiment.

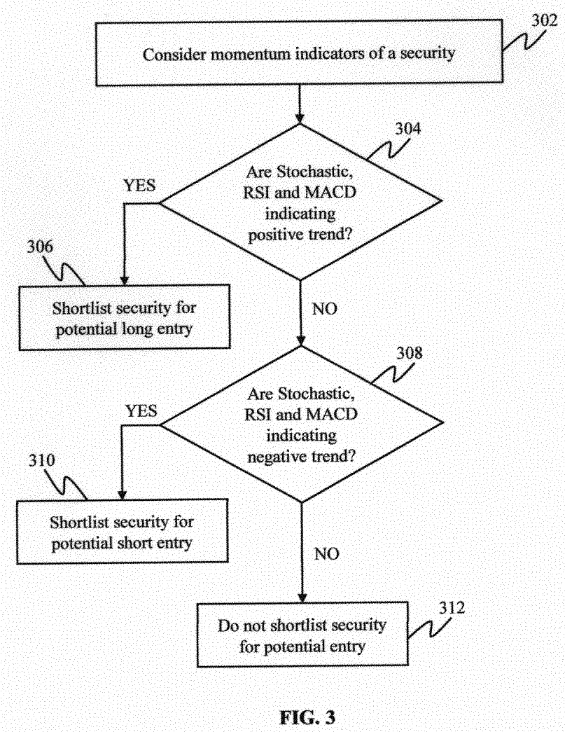

FIG. 2 illustrates a computerized recommendation method, carried out by the system 100, for trading securities listed in the stock exchange, in accordance with an embodiment.

FIG. 3 illustrates a computerized method of shortlisting securities based on momentum indicators, in accordance with an embodiment.

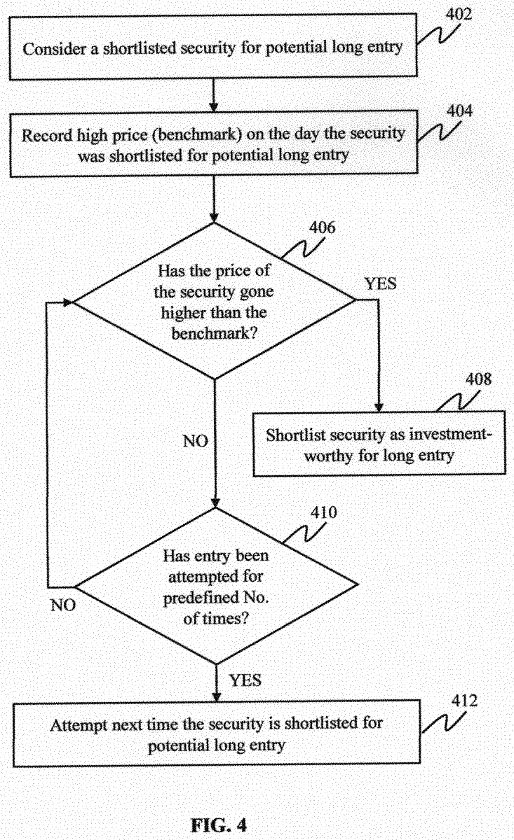

FIG. 4 illustrates a computerized method of processing shortlisted securities for assessing whether they are investment-worthy securities for long entry, in accordance with an embodiment.

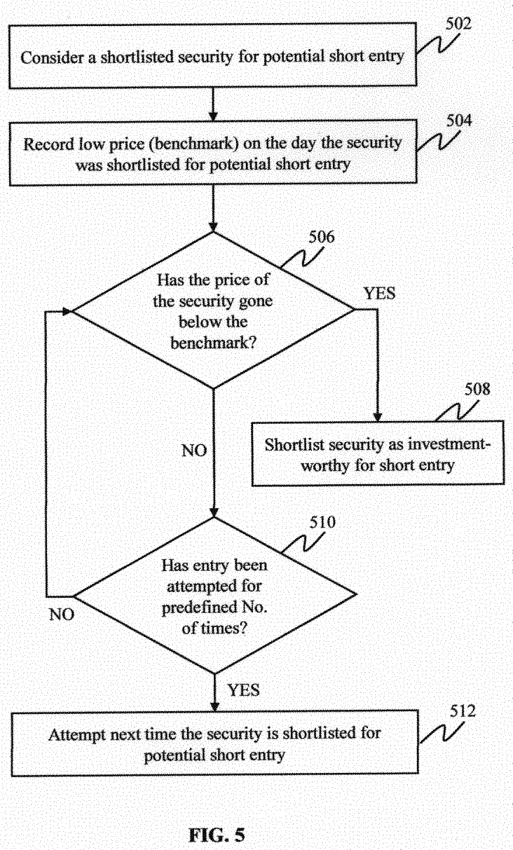

FIG. 5 illustrates a computerized method of processing shortlisted securities for assessing whether they are investment-worthy securities for short entry, in accordance with an embodiment.

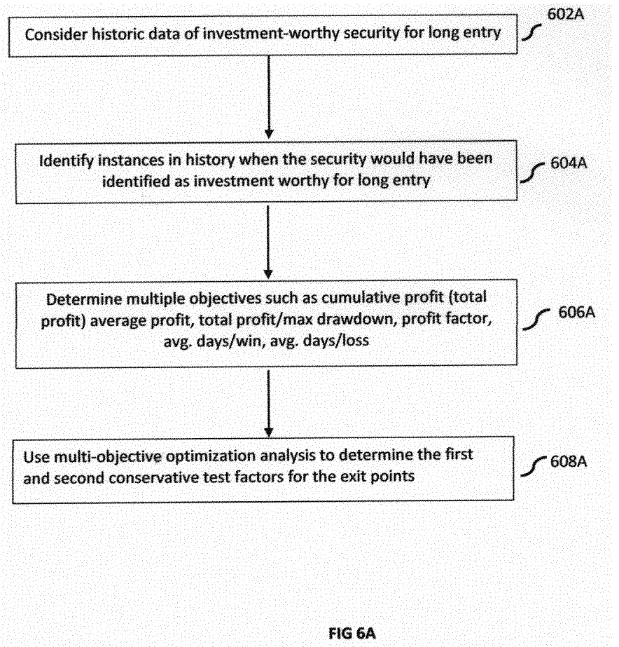

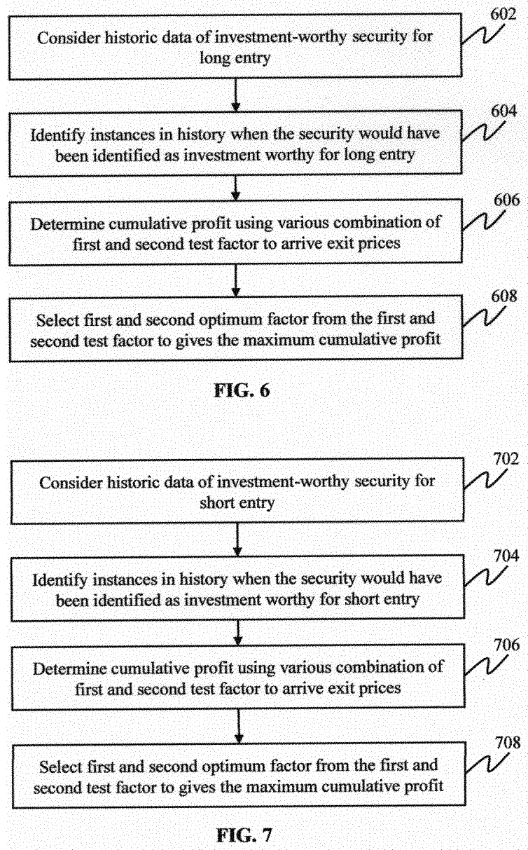

FIG. 6 illustrates a computerized method of determining first and second optimum factors for investment-worthy securities for long entry, in accordance with an embodiment.

FIG. 6A illustrates a computerized method of determining first and second conservative factors for investment worthy securities for long entry in accordance with an embodiment.

FIG. 7 illustrates a computerized method of determining first and second optimum factors for investment-worthy securities for short entry, in accordance with an embodiment.

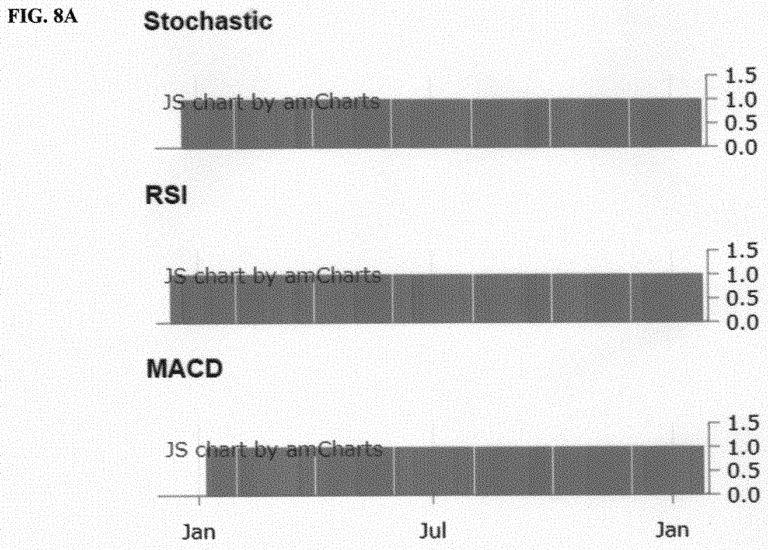

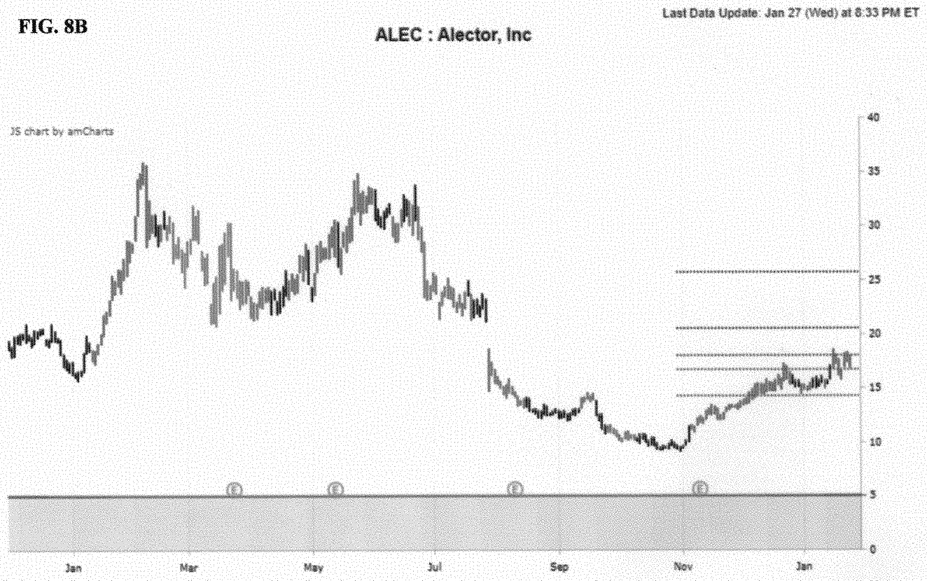

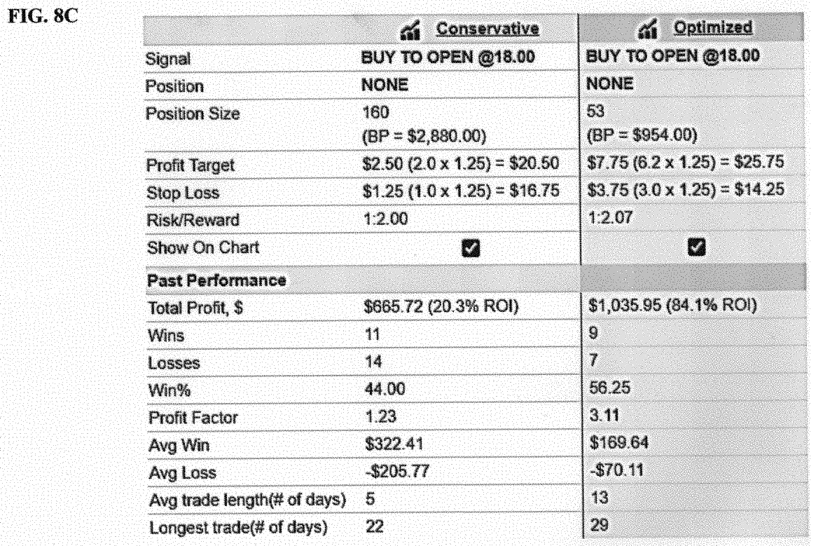

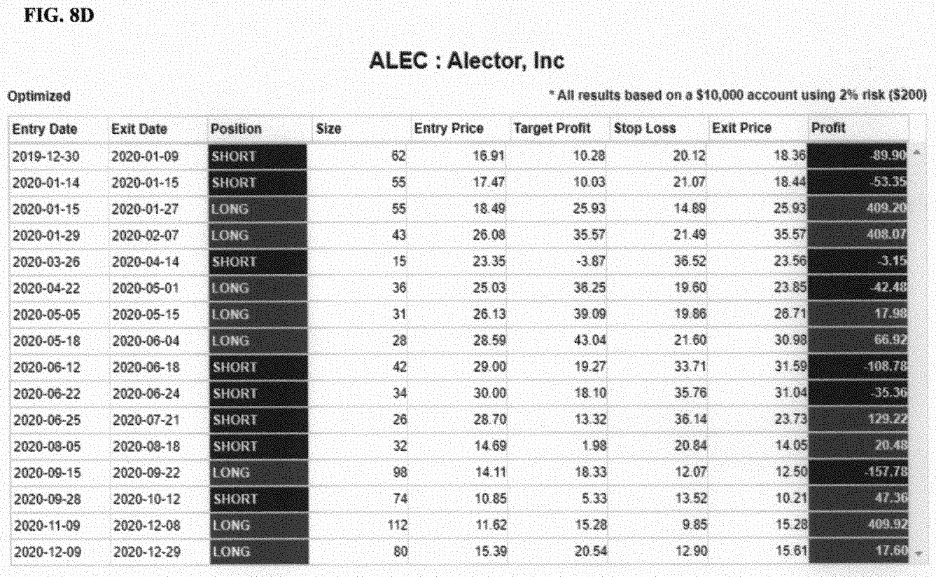

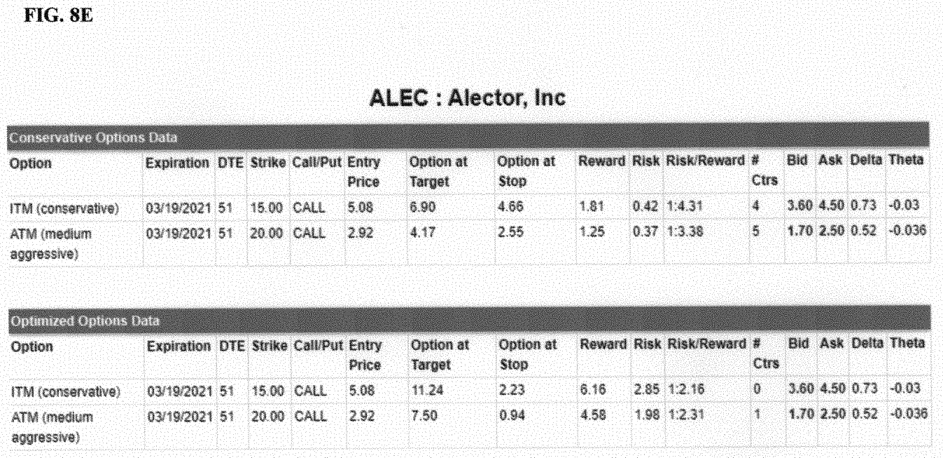

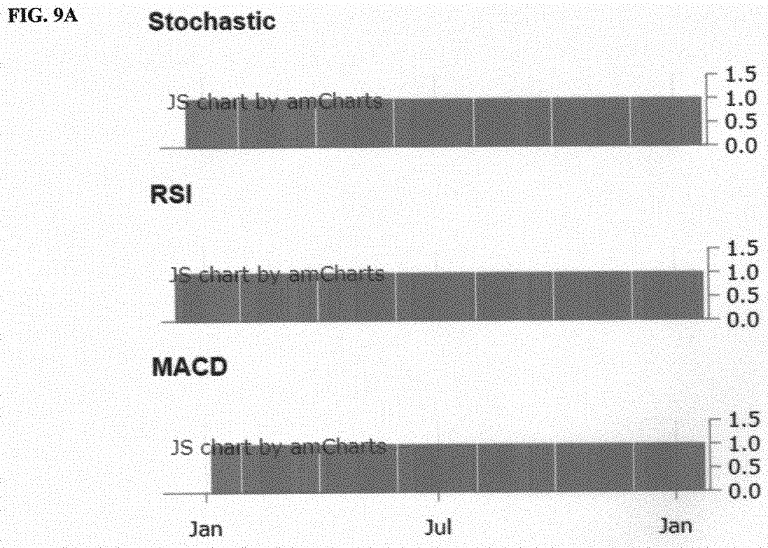

FIG. 8A illustrates three individual momentum indicators over a period of a security that may be considered for a long entry, in accordance with an embodiment.

FIG. 8B illustrates the bar chart of the security of FIG. 8A, in accordance with an embodiment.

FIG. 8C is a table illustrating past performance and recommendation corresponding to the security of FIG. 8A, in accordance with an embodiment.

FIG. 8D is a table illustrating historic profits at each of the instances in which the security of FIG. 8A became identified as investment-worthy, in accordance with an embodiment.

FIG. 8E is a table illustrating option recommendation for the security of FIG. 8A, in accordance with an embodiment.

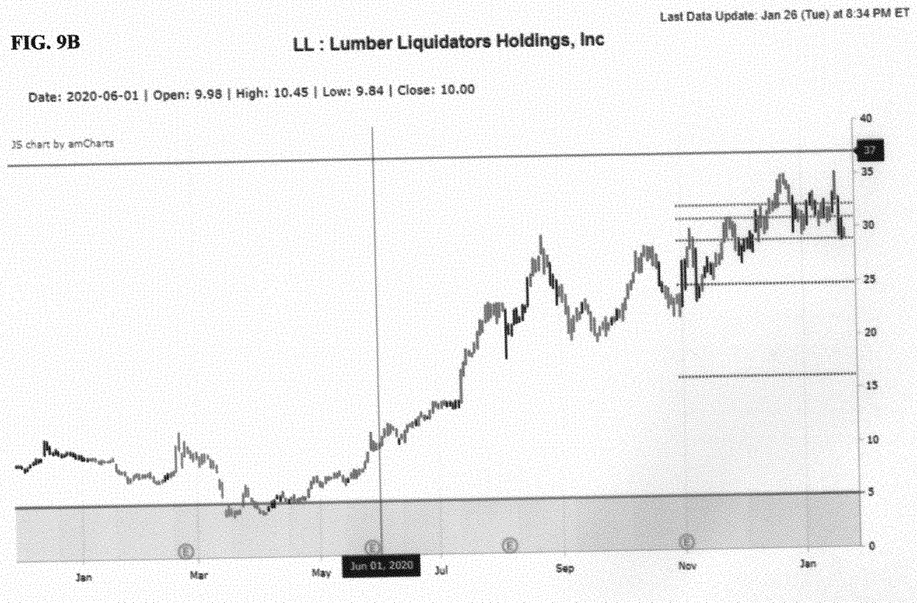

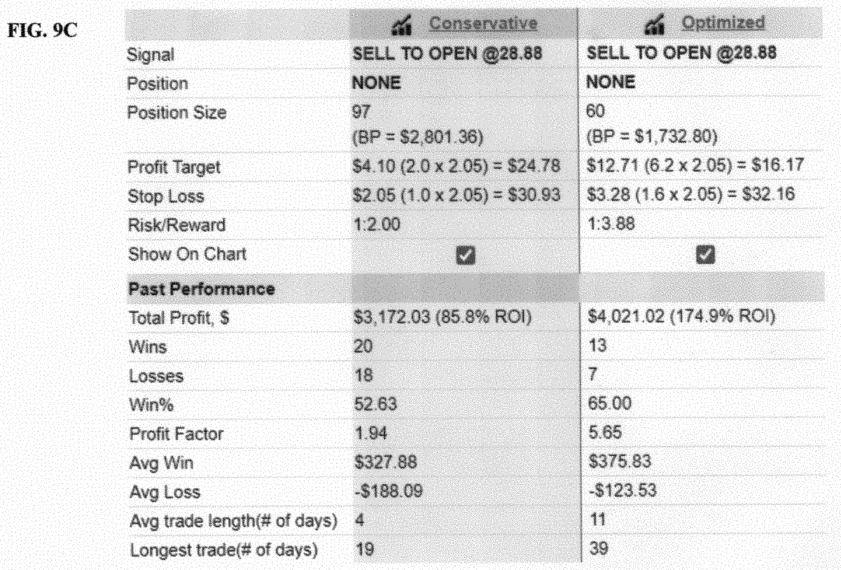

FIG. 9A illustrates three individual momentum indicators over a period of a security that may be considered for a short entry, in accordance with an embodiment.

FIG. 9B illustrates the bar chart of the security of FIG. 9A, in accordance with an embodiment.

FIG. 9C is a table illustrating past performance and recommendation corresponding to the security of FIG. 9A, in accordance with an embodiment.

### DETAILED DESCRIPTION

The following detailed description includes references to the accompanying drawings, which form part of the detailed description. The drawings show illustrations in accordance with example embodiments. These example embodiments are described in enough detail to enable those skilled in the art to practice the present subject matter. However, it may be apparent to one with ordinary skill in the art that the present invention may be practised without these specific details. In other instances, well-known methods, procedures and components have not been described in detail so as not to unnecessarily obscure aspects of the embodiments. The embodiments can be combined, other embodiments can be utilized, or structural and logical changes can be made without departing from the scope of the invention. The following detailed description is, therefore, not to be taken in a limiting sense.

In this document, the terms “a” or “an” are used, as is common in patent documents, to include one or more than one. In this document, the term “or” is used to refer to a non-exclusive “or”, such that “A or B” includes “A but not B”, “B but not A”, and “A and B”, unless otherwise indicated.

It should be understood that the capabilities of the invention described in the present disclosure and elements shown in the figures may be implemented in various forms of hardware, firmware, software, recordable medium or combinations thereof.

Disclosed is technical solution for recommending securities for trading. Broadly, the solution uses momentum indicators of securities to identify securities that may be considered for recommendation. Securities that satisfy certain criteria relating to momentum indicators are processed to determine whether they have reached certain trigger points, and those which have, may be considered investment worthy. Historical data corresponding to such investment-worthy securities is processed to identify optimized exit prices for profit target and stop loss. Further, those investment-worthy securities that meet user criteria at least based on historical performance, which may be derived using certain factors used for identifying the optimized exit prices, may be recommended to the user. Detailed explanation of the solution follows.

FIG. 1 illustrates a hardware configuration of a computerized recommendation system 100 for trading securities, in accordance with an embodiment.

In an embodiment, the system 100 may include one or more processors 10. The processor 10 may be implemented as appropriate in hardware, computer-executable instructions, firmware, or combinations thereof. Computer-executable instruction or firmware implementations of the processor 10 may include computer-executable or machine-executable instructions written in any suitable programming language to perform the various functions described. Further, the processor 10 may execute instructions, provided by the various modules of the system 100.

The system 100 may include a memory module 20. The memory module 20 may store additional data and program instructions that are loadable and executable on the processor 10, as well as data generated during the execution of these programs. Further, the memory module 20 may be volatile memory, such as random-access memory and/or a disk drive, or non-volatile memory. The memory module 20 may be removable memory such as a Compact Flash card, Memory Stick, Smart Media, Multimedia Card, Secure Digital memory, or any other memory storage that exists currently or will exist in the future.

The system 100 may include an input/output module 30. The input/output module 30 may provide an interface for inputting devices such as keypad, touch screen, mouse, and stylus among other input devices; and output devices such as speakers, printer, and additional displays among other.

The system 100 may include a display module 40 may be configured to display content. The display module 40 may also be used to receive an input from a user. The display module 40 may be of any display type known in the art, for example, Liquid Crystal Displays (LCD), Light emitting diode displays (LED), Orthogonal Liquid Crystal Displays (OLCD) or any other type of display currently existing or may exist in the future.

The system 100 may include a communication interface 50. The communication interface 50 may provide an interface between the system 100, server 106 and external networks. The communication interface 50 may include a modem, a network interface card (such as Ethernet card), a communication port, or a Personal Computer Memory Card International Association (PCMCIA) slot, among others. The communication interface 50 may include devices supporting both wired and wireless protocols.

FIG. 2 illustrates a computerized recommendation method for trading securities, in accordance with an embodiment. The method steps discussed in this specification may be carried out by the system 100 discussed above. The method comprises, at step 202, computing momentum indicators of the securities using data corresponding to the securities. At step 204, some of the securities may be shortlisted as to having potential of being recommended as an investment opportunity, on the basis of the momentum indicators. At 206, data corresponding to the shortlisted securities is processed to verify whether they meet a trigger threshold, and those which meet, may be considered investment-worthy securities.

At 208, optimized exit prices for meeting profit target and stop loss may be determined for the investment-worthy securities by processing historic data of such securities. At step 210, past performance parameters of the investment-worthy securities may be determined. At step 212, user selection criteria or preference and the past performance estimate of the investment-worthy securities are used to identify securities for recommendation to the user. At step 214, some of the parameters for consideration by the user may be customized based on the user selection criteria or preference and past performance estimate. For example, the user may select Conservative or Optimized data; Type of signal (Long only, or Short only, or Long and Short both); % Return on Investment. A long position refers to a purchase of a security in the expectation that its price will increase, whereas short position refers to borrowing of a security with the expectation that its price will fall. The term “short position” should not be confused with the term “shortlisted” which is used elsewhere in the document. A short, or a “short position”, is created when a trader sells a security first with the intention of repurchasing it or covering it later at a lower price. A trader may decide to short a security when she believes that the price of that security is likely to decrease in the near future. In contrast “shortlisted” refers to those securities that have the potential of being investment-worthy based on the criterion and mathematical algorithmic calculations herein disclosed in the present invention. These criteria are not limiting and shown to explain the flexibility of the invention to include User preferences.

The steps discussed above will now be discussed in greater detail. Referring to step 202, momentum indicators of the securities are computed. The system 100 may import Open, High, Low and Close (OHLC) corresponding to each of the securities from an external source. The system 100 may determine Average Daily Range (ADR) of each of the securities. The ADR may be a moving average over last predefined (e.g., 7 to 14) number of days, wherein the range may be computed as, high of the day minus low of the day. The system 100 may further compute three momentum indicators, viz., Stochastic, RSI and MACD. The momentum indicators are saved in a databased of the system 100.

Referring now to step 204, some of the securities may be shortlisted as to having potential of being recommended as an investment opportunity, on the basis of the momentum indicators. Referring to FIG. 3, momentum indicators of each of the securities are processed to determine whether or not the security may be shortlisted as having potential of being an investment-worthy security. As an example, the three momentum indicators of a security are retrieved from the database, at step 302. At step 304, the system 100 verifies whether all the three momentum indicators are indicating a positive trend. In case all the three momentum indicators are indicating a positive trend, then the system 100 may shortlist the security for a potential long entry, at step 306. On the other hand, if the system 100 determines, at step 308, that all the three momentum indicators are indicating a negative trend, then the system 100 may shortlist the security for a potential short entry, at step 310. Further, if the system determines, at step 312, that at least one of the three indicators indicates a trend different from at least one other indicator, then the system 100 may not shortlist the security for a potential entry.

In an embodiment, Stochastic indicates a positive trend if % K (14, 3, 3)>50, else Stochastic indicates a negative trend.

In an embodiment, RSI (7) indicates a positive trend if RSI>50, else RSI indicates a negative trend.

In an embodiment, MACD indicates a positive trend if MACD (12, 26, 9): MACD>Signal Line, else MACD indicates a negative trend.

In an embodiment, the momentum trends may be presented in charts and color coded. As an example, for a security, a signal line for the day may be color coded in, green when all the three momentum indicators are positive, red when all the three momentum indicators are negative and black when at least one of the momentum indicators has a trend different from that of at least one other momentum indicator.

Referring to FIG. 8A, the trends of the three momentum indicators of a particular security (ALECTOR, INC) over a period are illustrated separately. Green lines indicate positive trend, whereas red lines indicate negative trend. As can be seen, towards the present day (right hand side of the chart) all the momentum indicators are showing a positive trend. Consequently, as indicated in FIG. 8B, the color of the bar in the bar chart is green (positive trend) and may be shortlisted for a potential long entry. It may also be observed that there are red bars and black bars in the chart of FIG. 8B. The red bars are formed when all the momentum indicators have negative trend on the respective day, and black bars are formed when at least one of the momentum indicators is different from at least one other momentum indicator.

Referring to FIG. 9A, the trends of the three momentum indicators of a particular security (LUMBER LIQUIDATORS HOLDINGS INC) over a period are illustrated separately. Green lines indicate positive trend, whereas red lines indicate negative trend. As can be seen, towards the present day (right hand side of the chart) all the momentum indicators are showing a negative trend. Consequently, as indicated in FIG. 9B, the bar chart shows a red bar (negative trend) and may be shortlisted for a potential short entry.

Moving on and referring to step 206, data corresponding to the shortlisted securities is processed to verify whether they meet a trigger threshold, and those which meet, may be considered investment-worthy securities. As an example, referring to FIG. 4, at step 402, one of the securities shortlisted for potential long entry is considered for processing. At step 404, the system records, as a benchmark, a high price at the latest instance of the security when all the momentum indicators of the security first indicted the positive trend after a phase of at least one of the momentum indicators not indicating the positive trend. As an example, the high price of the security on the day the security turned “green” from being “red” or “black”, is recorded as benchmark. The system 100, at step 406, may check on the close of the trading day and determine the status of the share for a potential entry on the next day. In case the price of the security is assessed to be at the benchmark at the close of the trading day, then at step 408, the system 100 identifies the security as investment-worthy security for long entry at a price that is one cent higher than the benchmark price. On the other hand, if the assessment is negative at step 406, then the system 100 may carry out the step of 406 for a predefined number of instances (step 410) (e.g., predefined number of days from the first day), and may only consider the security for assessment for being an investment-worthy security for a long entry the next time the security is shortlisted for a potential long entry (step 412).

Securities shortlisted for potential short entry may be processed in an analogous manner. As an example, referring to FIG. 5, at step 502, one of the securities shortlisted for potential short entry is considered for processing. At step 504, the system records, as a benchmark, a low price at a latest instance of the security when all the momentum indicators of the security first indicted the negative trend after a phase of at least one of the momentum indicators not indicating the negative trend. As an example, the low price of the security on the day the security turned “red” from being “green” or “black”, is assessed to be the benchmark at close of the trading day, then at step 508, the system 100 identifies the security as investment-worthy security for a short entry at a price that is one cent lower than the benchmark price. security for short entry. On the other hand, if the assessment is negative at step 506, then the system 100 may carry out the step of 506 for a predefined number of instances (step 510) (e.g., predefined number of days from the first day), and may only consider the security for assessment for being an investment-worthy security for a short entry the next time the security is shortlisted for a potential short entry (step 512).

Moving on to step 208, optimized exit prices for meeting profit target and stop loss may be determined for the investment-worthy securities by processing historic data (e.g., data of past 12 months) of such securities. Profit target may be equal to First test factor*ADR and stop loss may be equal to Second test factor*ADR.

As an example, referring to FIG. 6, historic data corresponding to the security is considered at step 602. At step 604, all the instances in history in which the security would have been identified as investment-worthy security by applying the same logic as discussed earlier, may be identified. At step 606, the system 100 may determine multiple total profits of all the identified instances, using a combination of a series of first test factors and a series of second test factors to determine the exit prices at each of the instances.

As an example, exit price for profit in a long position may be, Entry Price+first test factor*ADR, and likewise exit price for stop loss in a long position may be, Entry Price−second test factor*ADR.

Likewise, as an example, exit price for profit in a short position may be, Entry Price−first test factor*ADR, and likewise exit price for stop loss in a long position may be, Entry Price+second test factor*ADR.

As an example, as may be understood from table below, the system 100 may determine multiple total profits of all the identified instances, using a combination of a series of first test factors and a series of second test factors to determine the exit prices at each of the instances.

| First test factor | Second test factor |
|---|---|
| 0.8 | 0.8 |
| 0.8 | 1.0 |
| 0.8 | 1.2 |
| 0.8 | 1.4 |
| 0.8 | 1.6 |
| 0.8 | 1.8 |
| 0.8 | 2.0 |
| 0.8 | 2.2 |
| 0.8 | 2.4 |
| 0.8 | 2.6 |
| 0.8 | 2.8 |
| 0.8 | 3.0 |
| 1.0 | 0.8 |
| 1.0 | 1.0 |
| 1.0 | 1.2 |
| — | — |
| — | — |
| 10 | 3 |

As one can understand, for different combinations of first and second test factor, the exit prices at each of the instances changes, and the outcome of investment at those instances also changes, and thereby also changing the total profit resulting from the outcome at each of the instances. At one of the combinations of the first and second test factor, the total profit would be maximum compared to the rest, and such first and second test factor may be considered as the optimum first and second factor for recommendation at the current instance (step 608). The first and the second optimum factors are used to determine the optimized exit prices for profit and stop loss for recommendation in the current instance. Profit is the money made on exiting a trade, whereas stop loss is limiting a loss incurred on exiting a trade. Referring to FIG. 8D, profits that may have resulted in the past, based on the first and the second optimum factors currently determined, are computed and a total profit is computed.

In an embodiment, the first test factors are numbers varying within a first range and the second test factors are numbers varying within a second range. The first range may be between 0.8 and 10, and the second range may be between 0.8 and 3.

The method discussed above may be adapted for investment-worthy securities for short entry, as illustrated in FIG. 7, in which the steps of 702-708 are carried out for investment-worthy securities for short entry.

Moving on to step 210, past performance parameters of the investment-worthy securities may be determined using the first and the second optimum factors. Such past performance information is illustrated in FIG. 8C and 9C. The performance factors may include the total number of wins (instances when the investment would have yielded profit) and the total number of losses (instances when the investment would have resulted in loss) in the past instances resulting using the investments made using the first and the second optimum factors.

In an embodiment, performance factors may include a profit factor in the past instances resulting using the investments made using the first and the second optimum factors. In an embodiment, Profit Factor=(number of wins*average profit/number of losses*average loss).

In an embodiment, performance factors may include percentage of wins, in the past instances resulting using the investments made using the first and the second optimum factors.

Moving on to step 212, user selection criteria or preference and the past performance estimate of the investment-worthy securities may be used to identify securities for recommendation to the user. In an embodiment, user profile and selection criteria may include one or more of, type of entries the user is interested in, such as, long only, short only or long as well as short, return on investment, security price range, minimum profit factor, minimum reward/risk ratio (Stop Loss/Profit Target), minimum number of trades, minimum win percentage and minimum average volume of shares traded. The user profile may also state total amount that may be available for investment and risk percentage. The total amount that may be available for investment may be referred to as account size, which may be in currency like USD. The account size and the risk percentage may be used to compute a risk amount, wherein the risk amount may be equal to Account size*risk percentage/100 The system 100 may select securities among the investment-worthy securities for recommendation which meet the user selection criteria based on at least the past performance discussed earlier.

Moving on to step 214, some of the parameters during recommendation, for consideration by the user may be customized based on the user selection criteria or preference and the past performance estimate. One such parameter may include position size. The position size is determined based on the total risk the user chooses to take based on his or her aversion or attraction for risk. The user's total investible cash in his or her account is placed against a calculatable risk taking capacity which is based on the total maximum stop loss which is possible should the security move in a direction against the hopes of the user's desired direction. Position size may be calculated as risk amount divided by the stop loss (risk amount/stop loss). Another such parameter may include, total profit considering investments if made in the past instances using the recommendation logic explained earlier. Yet another parameter may include, average profit considering investments, if made, in the past instances using the recommendation logic explained earlier. Yet another parameter may include, average loss considering investments, if made, in the past instances using the recommendation logic explained earlier. Yet another parameter may include, return on investments, which may be equal to: Total net profit/capital employed calculated in percentage to show an annual return.

In an embodiment only long entries are considered from all the security worthy investments (Step 408). The first test factors are numbers varying within a first range and the second test factors are numbers varying within a second range. The first range may be an integer between 1 to 10, with increments of 1 and the second range may be between 0.5 and 2.5 with increments of 0.5. In this embodiment only the exits when changing for green to red bars were considered and black bar exits were ignored.

As an example, referring to FIG. 6A, historic data corresponding to the security is considered at step 602A. At step 604A, all the instances in history in which the security would have been identified as investment-worthy security by applying the same logic as discussed earlier, may be identified. At step 606A, the system 100 may determine multiple objectives such as cumulative (total) profit, average profit, (=total profit/number of trades), profit factor, average days for a profit(win), average days for a loss. The term drawdown (DD) is well known in the Art. It refers to how much an investment is down from its peak before it recovers.

These multiple average factors may be analyzed using multi objective analysis to determine the first and second factors for exits (step 608A) As an example, refer to the table below that shows a typical analysis of historical data wherein the system may be configured to make recommendation based on multiple objectives and rank them. The average rank is calculated, and the lowest number is chosen as the best factors to use. In this example, the ftf=5 and the stf=2.5 gives the lowest average rank and is consequently the “best” choice. Other methodologies for multi-objective optimization such as Pareto optimization may also be used to arrive at the best fixed factors to use for determining the exit points. Such an approach may be referred to as “conservative” approach as compared to the “optimized” approach discussed throughout this specification. The system may be configured to provide a comparison between the “conservative” and “optimized” approach. Furthermore, the user may also be allowed to select one or more of “conservative” and “optimized” approach for the system to make recommendations to the user.

| | | TP | | AP | | | | | | | | | |
|---|---|---|---|---|---|---|---|---|---|---|---|---|---|
| AR | ftf/stf | $mm | R | $ | R | TP/DD | R | PF | R | ADW | R | ADL | R |
| 4.33 | 7.0/1.0 | 1.43 | 5 | 204 | 5 | 4.39 | 5 | 1.86 | 5 | 42.2 | 2 | 10.18 | 4 |
| 3.83 | 7.5/1.5 | 1.81 | 4 | 354 | 4 | 5.52 | 4 | 2.15 | 4 | 55.7 | 4 | 18.25 | 3 |
| 3.16 | 6.0/2.0 | 2.12 | 3 | 429 | 3 | 7.95 | 2 | 2.33 | 3 | 44.5 | 3 | 1.71 | 5 |
| 1.67 | 5.0/2.5 | 2.24 | 2 | 448 | 2 | 9.16 | 1 | 2.39 | 2 | 36.01 | 1 | 19.2 | 2 |
| 2.0 | 7.5/2.5 | 2.32 | 1 | 643 | 1 | 6.39 | 3 | 2.67 | 1 | 64.47 | 5 | 26.69 | 1 |

In Table above abbreviations mean as follows
AR = average rank, R = rank, ftf = first test factor, stf = second test factor, TP = Total profit, AP = Average profit DD = max. drawdown, PF = Profit Factor ADW = average days for Win, ADL = average days for loss. Rankings are based as follows: TP high to low (1 to 5); AP high to low (1 to 5); TP/DD high to low (1 to5); PF high to low (1 to 5); ADW low to high (1 to 5); ADL high to low (1 to 5).

In an embodiment, as illustrated in FIG. 8E, the system may be configured to recommend the parameters for options based on both the “conservative” and “optimized” approach.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A computerized recommendation system for trading securities listed in a stock exchange, the system comprising at least one processor configured to:
compute and store in a non-transitory memory system, multiple momentum indicators for each of a plurality of securities;
process the momentum indicators to shortlist securities, among the plurality of securities, that either have all their respective momentum indicators indicating a positive trend or a negative trend;
process data corresponding to the shortlisted securities, to identify investment-worthy securities among the shortlisted securities, based on predefined criteria;
determine at least a pair of current optimized exit price for each of the investment-worthy securities by processing historic data respective to each of the shortlisted securities.

2. The computerized recommendation system according to claim 1, wherein the at least one processor is configured to, for each of the investment-worthy:
process the historic data to identify instances, in the past, when the investment-worthy security would qualify as the investment-worthy security based on the predefined criteria; and
compute notional pair of exit price for each of the identified instances that provides maximum profit cumulative of all the identified instances.

3. The computerized recommendation system according to claim 2, wherein the at least one processor is configured to, for each of the investment-worthy securities, determine a first optimum factor and a second optimum factor, used respectively for arriving at a first and a second exit price of the pair of exit price at each of the instances, which provides the maximum profit cumulative (total profit) of all the identified instances.

4. The computerized recommendation system according to claim 3, wherein the at least one processor is configured to, determine a first and a second of the pair of the current optimized exit price for the security by multiplying the first optimum factor with an average daily range of the investment-worthy security and multiplying the second optimum factor with the average daily range of the investment-worthy security, respectively.

5. The computerized recommendation system according to claim 4, wherein the at least one processor is configured to, for determining the first optimum factor and the second optimum factor, determine the profit cumulative of all the identified instances, using a combination of a series of first test factors (ftf) and a series of second test factors (stf), and selecting the first optimum factor and the second optimum factor from the series of the first test factors and the series of the second test factors, respectively, that provides the maximum profit cumulative of all the identified instances.

6. The computerized recommendation system according to claim 5, wherein the first test factors are numbers varying within a first range and the second test factors are numbers varying within a second range.

7. The computerized recommendation system according to claim 6, wherein the first range is between 0.8 and 10 and the second range is between 0.8 and 3.

8. The computerized recommendation system according to claim 3, wherein the at least one processor is configured to, for each of the investment-worthy securities, process the historic date to determine whether outcome in each of the instances would be a positive or a negative outcome in case of investment exited as per the first optimum factor and the second optimum factor.

9. The computerized recommendation system according to claim 8, wherein the at least one processor is configured to, display on a user interface, the total number of the determined positive and negative outcome for the investment-worthy security.

10. The computerized recommendation system according to claim 1, wherein, for identifying the investment-worthy securities, the at least one processor is configured to, for each of the shortlisted securities having all their respective momentum indicators indicating the positive trend:
retrieve, from a non-transitory memory system, a high price at a latest instance of the shortlisted security when all the momentum indicators of the shortlisted security first indicted the positive trend after a phase of at least one of the momentum indicators not indicating the positive trend;
retrieve, from the non-transitory memory system, the prices of the shortlisted security when all the momentum indicators of the security indicted positive trend subsequent to the latest instance; and
compare the high price of the first instance and the prices in the subsequent instance; and
consider the shortlisted security as the investment-worthy security, if any of the prices in the subsequent instance is greater than the high price of the latest instance.

11. The computerized recommendation system according to claim 1, wherein, for identifying the investment-worthy securities, the at least one processor is configured to, for each of the shortlisted securities having all their respective momentum indicators indicating the negative trend:
retrieve, from a non-transitory memory system, a low price at a latest instance of the shortlisted security when all the momentum indicators of the shortlisted security first indicted the negative trend after a phase of at least one of the momentum indicators not indicating the negative trend;
retrieve, from the non-transitory memory system, the prices of the shortlisted security when all the momentum indicators of the security indicted negative trend subsequent to the latest instance; and
compare the low price of the first instance and the prices in the subsequent instance; and
consider the shortlisted security as the investment-worthy security, if any of the prices in the subsequent instance is lesser than the low price of the first instance.

12. The computerized recommendation system according to claim 1, wherein the at least one processor is configured to:
receive security selection criteria from a user device; and
identify one or more recommended securities among the investment-worthy securities by correlating the selection criteria with performance estimated at least using the pair of current optimized exit price.

13. The computerized recommendation system according to claim 12, wherein the selection criteria comprise an investment amount and a risk amount, wherein the at least one processor is configured to determine number of securities recommended for investment based at least on the investment amount, the risk amount and one among the pair of current optimized exit price, which is optimized to stop loss.

14. The computerized recommendation system according to claim 13, wherein the selection criteria comprise a preferred percentage wins, wherein the at least one processor is configured to identify the recommended securities among the investment-worthy securities based on number of wins, historically, that would be gained by investments in the recommended security using one or more numerical factors used for determining the pair of the current optimized exit price.

15. The computerized recommendation system according to claim 14, wherein the selection criteria comprise a preferred return on investment, wherein the at least one processor is configured to identify the recommended securities among the investment-worthy securities based total return on investment, historically, that would be gained by investments in the recommended security using one or more numerical factors used for determining the pair of the current optimized exit price.

16. The computerized recommendation system according to claim 1, wherein the at least one processor is configured to at least a pair of conservative exit price for each of the investment-worthy securities by using a pair pre-configured factors.

17. The computerized recommendation system for trading securities listed in a stock exchange, wherein the at least one processor is further configured to determine at least a pair of current optimized exit price of options for each of the investment-worthy securities by processing the historic data respective to each of the shortlisted securities
